(19) United States
(12) Patent Application Publication
(10) Pub. No.: US 2006/0280484 A1
(43) Pub. Date: Dec. 14, 2006

(54) Recording/playback apparatus and recording/playback method

(75) Inventor: Kenichi Douniwa, Asaka-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA.

(21) Appl. No.: 11/447,876

(22) Filed: Jun. 7, 2006

(30) Foreign Application Priority Data
Jun. 8, 2005 (JP) 2005-168343

(51) Int. Cl. H04N 7/26

(52) U.S. Cl. 386/112

(57) ABSTRACT

According to one embodiment, in a recording/playback method, based on a guaranteed performance for guaranteeing a real-time operation for each unit which performs various processes for a recording/playback process, and required performances for each unit in executing the various processes, a sum of the required performances for each unit in executing a plurality of designated real-time processes is calculated, and the sum of the required performances for each unit is compared with the guaranteed performance for each unit. When the sum of the required performances for the plurality of the real-time processes does not exceed the guaranteed performance, the plurality of designated real-time processes are executed. On the other hand, when the sum of the required performances for the plurality of the real-time processes exceeds the guaranteed performance, some of the plurality of designated real-time processes are changed, and the changed processes are executed.

### CROSS-REFERENCE TO RELATED APPLICATIONS

This application is based upon and claims the benefit of priority from Japanese Patent Application No. 2005-168343, filed Jun. 8, 2005, the entire contents of which are incorporated herein by reference.

### BACKGROUND

1. Field

One embodiment of the invention relates to a recording/playback apparatus and recording/playback method for executing a plurality of applications required for a recording/playback process.

2. Description of the Related Art

In recent years, a recording/playback apparatus which mounts a DVD drive and a hard disk drive has been very popular. Such recording/playback apparatus can simultaneously execute a plurality of processes in real time, for example, recording one program while playing back another. When a plurality of processes are to be simultaneously executed in real time, the processing performance (processing capability) of each unit which performs various processes becomes an issue. That is, when a load exceeds the processing performance of each unit in executing a plurality of processes, a processing delay (real-time processing error) occurs.

For example, in Jpn. Pat. Appln. KOKAI Publication No. 2002-165115, the following technique has been disclosed. In this technique, a resource such as a hard disk is shared. In executing an uninterruptible process and a background process other than the uninterruptible process, a required hard disk access bandwidth is allocated to the uninterruptible process, and after that, the remaining amount of bandwidth is calculated to allocate the maximum hard disk access bandwidth to the background process within the range of the remaining amount of bandwidth.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a block diagram showing the schematic arrangement of a recording/playback apparatus according to an embodiment of the invention;

FIG. 2 is a table showing the examples of performances required for a TV viewing process (playback process) according to the embodiment;

FIG. 3 is a table showing the examples of performances required for a recording process without a transcodec according to the embodiment;

FIG. 4 is a table showing the examples of performances required for a recording process with the transcodec according to the embodiment;

FIG. 5 is a table showing the examples of performances required for each combining process according to the embodiment;

FIG. 6 is a table showing the examples of performances required for a TV viewing process (playback process), and an omissible process according to the embodiment;

FIG. 7 is a table showing the examples of performances required for a recording process without the transcodec, and an omissible process according to the embodiment;

FIG. 8 is a table showing the examples of performances required for a recording process with the transcodec, and an omissible process according to the embodiment;

FIG. 9 is a table showing the examples of performances required for each combining process according to the embodiment; and

FIG. 10 is a flowchart for explaining an example of the operation control of a real-time process.

### DETAILED DESCRIPTION

Various embodiments according to the invention will be described hereinafter with reference to the accompanying drawings. In general, according to one embodiment of the invention, a recording/playback method comprises calculating, based on a guaranteed performance for guaranteeing a real-time operation for each unit which performs various processes for a recording/playback process, and required performances for each unit in executing the various processes, a sum of the required performances for each unit in executing a plurality of designated real-time processes, and comparing the sum of the required performances for each unit with the guaranteed performance for each unit, and executing, when the sum of the required performances for the plurality of the real-time processes does not exceed the guaranteed performance, the plurality of designated real-time processes, and changing, when the sum of the required performances for the plurality of the real-time processes exceeds the guaranteed performance, some of the plurality of designated real-time processes and executing the changed processes.

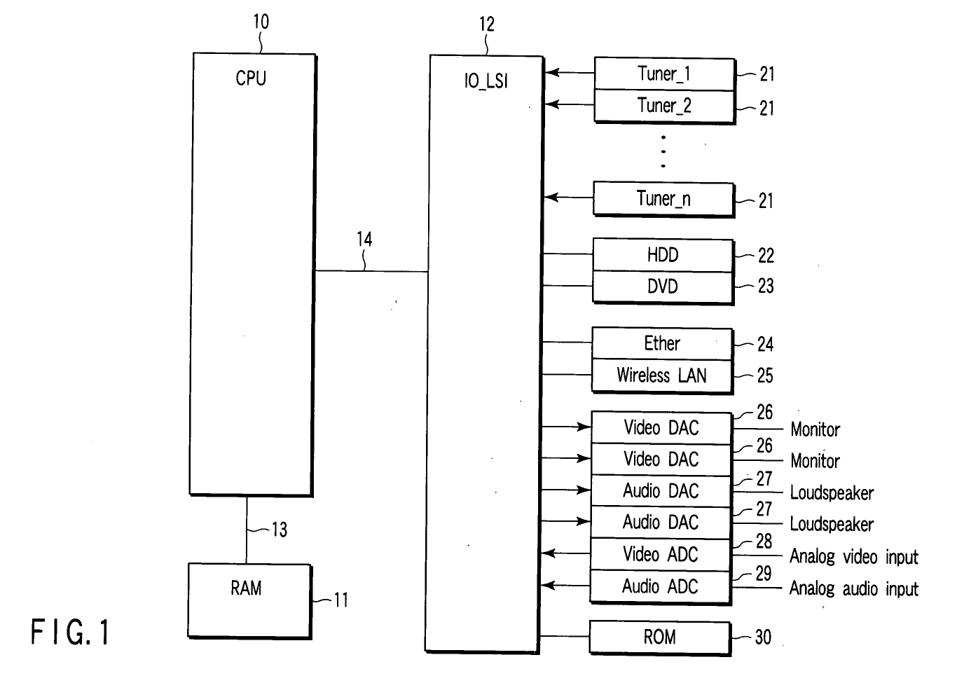

FIG. 1 is a block diagram showing the schematic arrangement of a recording/playback apparatus according to an embodiment. The recording/playback apparatus shown in FIG. 1 can process a plurality of application software programs to be subjected to a real-time process. This recording/playback apparatus includes a CPU 10 which is specialized to multimedia application, a memory (RAM) 11, an IO_LSI 12 which mounts various I/Os, a memory bus 13 which satisfies bandwidth guarantee between the CPU 10 and the memory 11, an I/O bus 14 which satisfies bandwidth guarantee between the CPU 10 and the IO_LSI 12, a plurality of tuners 21 such as a BS/CS digital tuner, terrestrial digital tuner, and terrestrial analog tuner, a hard disk drive (HDD) 22, a recordable DVD drive 23, an Ethernet® interface 24, a wireless LAN card 25, a video D/A converter 26, an audio D/A converter 27, a video A/D converter 28, an audio A/D converter 29, a ROM 30, and the like.

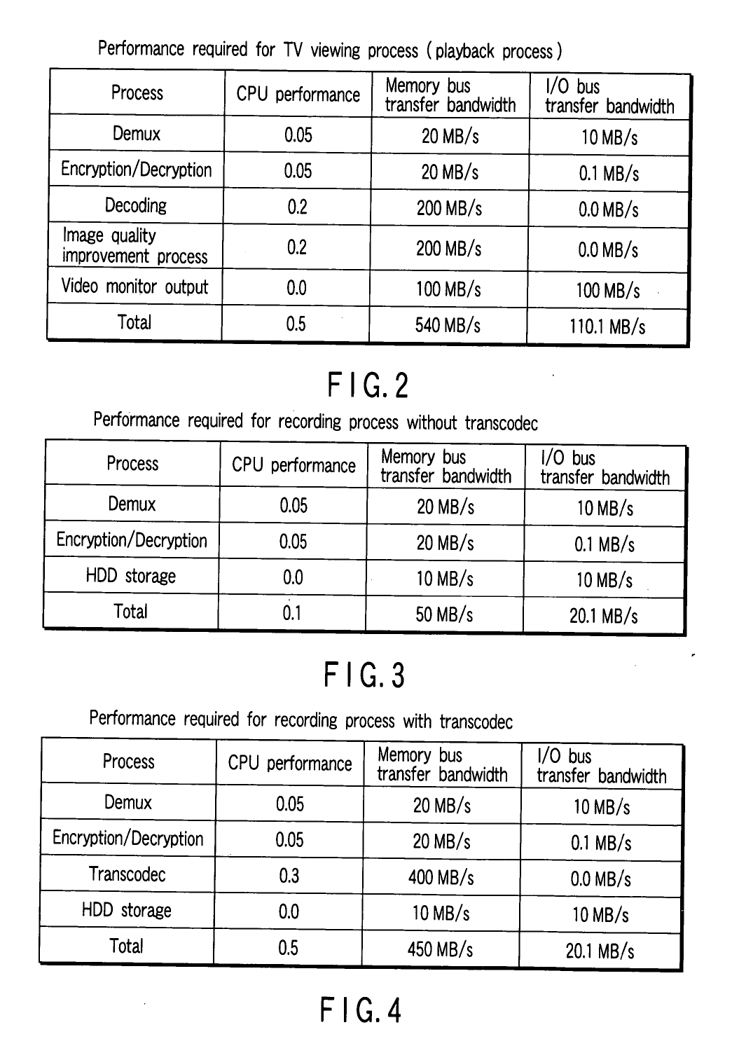

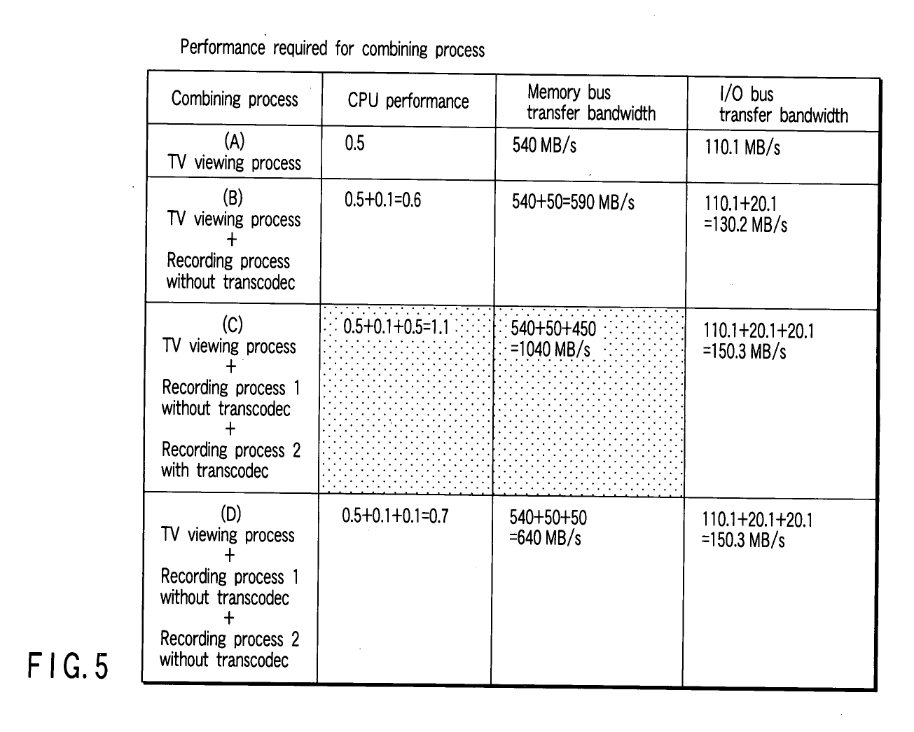

The basic operation of the above-described recording/playback apparatus will be described below. As shown in FIGS. 2, 3, and 4, required performances are prepared in advance for each application software program to be subjected to the real-time process. That is, the performances required for each unit (e.g., CPU 10, memory bus 13, or I/O bus 14) in executing various processes (e.g., demux, encryption/decryption, decoding, image quality improvement, video monitor output, HDD storage, and transcodec) for performing the recording/playback process are prepared. Accordingly, the ROM 30 stores the performances required for each unit in executing the various processes as shown in FIGS. 2, 3, and 4.

In order to operate a plurality of designated application software programs, it is determined, with reference to the required performances shown in FIGS. 2, 3, and 4, whether the performance of the CPU 10 and the transfer bandwidths of the memory bus 13 and I/O bus 14 are enough. If the performance and the transfer bandwidths are enough, the plurality of designated application software programs can be operated. On the other hand, if the performance and the transfer bandwidths are not enough, some of the plurality of designated application software programs are changed to reduce the load on each unit, and these application software programs can be operated. Accordingly, the plurality of application software programs to be subjected to the real-time process can be operated without losing a real-time operation.

For example, assume that the real-time operation can be guaranteed until the performance of the CPU 10 exceeds 1.0, the transfer bandwidth of the memory bus 13 exceeds 1.0 GB/s, and the transfer bandwidth of the I/O bus 14 exceeds 400 MB/s. That is, the ROM 30 stores a guaranteed performance (information representing that the real-time operation is guaranteed until the performance of the CPU 10 exceeds 1.0, the transfer bandwidth of the memory bus 13 exceeds 1.0 GB/s, and the transfer bandwidth of the I/O bus 14 exceeds 400 MB/s) for guaranteeing the real-time operation, for each unit (e.g., CPU 10, memory bus 13, or I/O bus 14) which performs various processes for the recording/playback process.

The execution of the following processes (A) to (C) will be considered.

(A) TV viewing process

(B) TV viewing process and recording process without transcodec

(C) TV viewing process, recording process 1 without transcodec, and recording process 2 with transcodec

FIG. 5 shows the calculation results of the performance of the CPU 10 and the transfer bandwidths of the memory bus 13 and I/O bus 14, which are required for performing each process (A), (B), or (C).

That is, since the performance in the process (A) does not exceed the system performance for guaranteeing the real-time operation, the TV viewing process can be executed in real time.

Similarly, since the performance in the process (B) does not exceed the system performance for guaranteeing the real-time operation, the TV viewing process and the recording process without a transcodec can be executed in real time.

However, since the performance in the process (C) exceeds the system performance for guaranteeing the real-time operation, the three processes, i.e., the TV viewing process, the recording process 1 without the transcodec, and the recording process 2 with the transcodec cannot be executed in real time.

To cope with this, some of the plurality of real-time processes are changed (to reduce a load) to execute these processes. For example, the following process (D) is executed.

(D) TV viewing process, recording process 1 without transcodec, and recording process 2 without transcodec

FIG. 5 shows the calculation results of the performance of the CPU 10 and the transfer bandwidths of the memory bus 13 and I/O bus 14, which are required for performing the process (D). As shown in FIG. 5, since the performance in the process (D) does not exceed the system performance for guaranteeing the real-time operation, the three processes, i.e., the TV viewing process, the recording process 1 without the transcodec, and the recording process 2 without the transcodec can be executed in real time. Note that, for example, the transcodec is a process of converting MPEG2 data into MPEG4 data, and imposes a relatively heavy load.

As described above, the real-time operation can be guaranteed by checking the real-time operation before starting the real-time process.

In the above description, the recording process with the transcodec is changed to that without the transcodec in order to reduce the load. In this case, for example, by default setting or user setting, the nonvolatile area of the memory 11 stores information which allows to change the recording process with the transcodec to that without the transcodec. With reference to this information, the CPU 10 determines that the plurality of processes including the recording process with the transcodec cannot be executed in real time. In accordance with this determination, the recording process with the transcodec is changed to that without the transcodec of the plurality of designated real-time processes, thereby executing the changed process.

When a recording destination is a hard disk drive (having a relatively large storage capacity), the recording process with the transcodec may be allowed to be changed to that without the transcodec. On the other hand, when the recording designation is a DVD (having a relatively small storage capacity), the recording process with the transcodec may be inhibited to be changed to that without the transcodec.

However, in the above-described load reduction method, the process (C) (the TV viewing process, the recording process 1 without the transcodec, and the recording process 2 with the transcodec) cannot be executed, and the process (D) (the TV viewing process, the recording process 1 without the transcodec, and the recording process 2 without the transcodec) can be executed. In order to execute the recording process 1 without the transcodec and the recording process 2 with the transcodec, the following method may be employed.

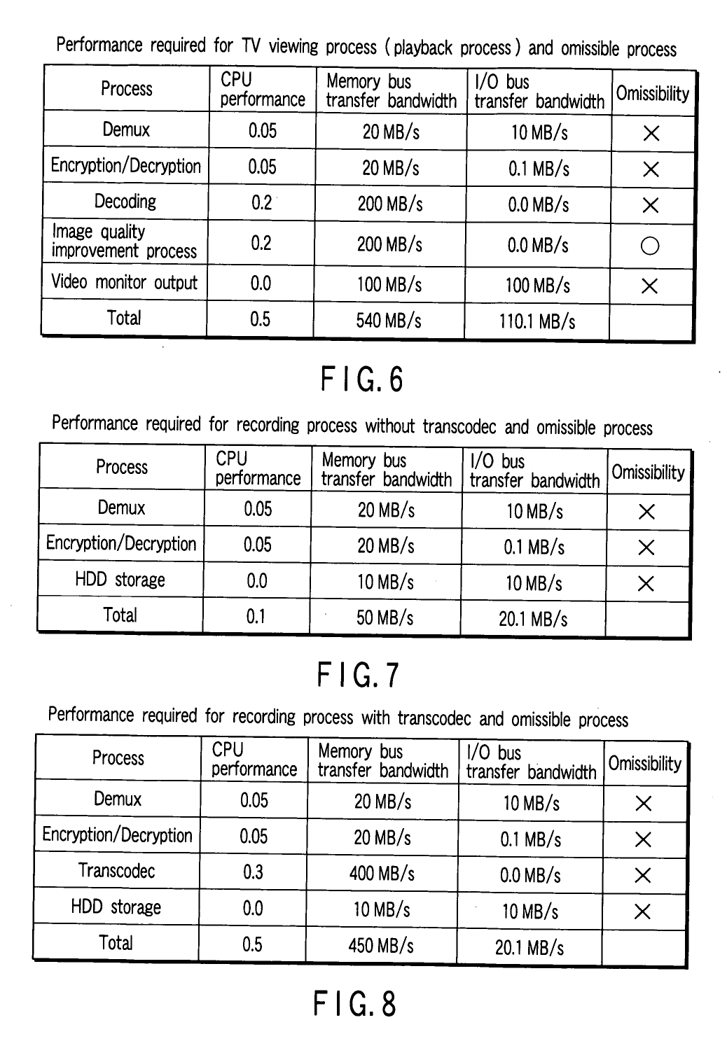

For example, as shown in FIGS. 6, 7, and 8, pieces of information pertaining to the performances and an omissible process for each application are prepared in advance. In order to operate the application software, it is determined, with reference to the information pertaining to the required performances and omissible process shown in FIGS. 6, 7, and 8, whether the performance of the CPU 10 and the transfer bandwidths of the memory bus 13 and I/O bus 14 are enough. If the performance and the transfer bandwidths are enough, the plurality of designated application software programs can be operated. On the other hand, if the performance of the CPU 10 and the transfer bandwidths of the memory bus 13 and I/O bus 14 are not enough, a changeable (omissible) program of the plurality of designated application programs is changed (omitted), and it is determined again whether the performance of the CPU 10 and the transfer bandwidths of the memory bus 13 and I/O bus 14 are enough.

For example, assume that the real-time operation is guaranteed until the performance of the CPU 10 exceeds 1.0, the transfer bandwidth of the memory bus 13 exceeds 1.0 GB/s, and the transfer bandwidth of the I/O bus 14 exceeds 400 MB/s.

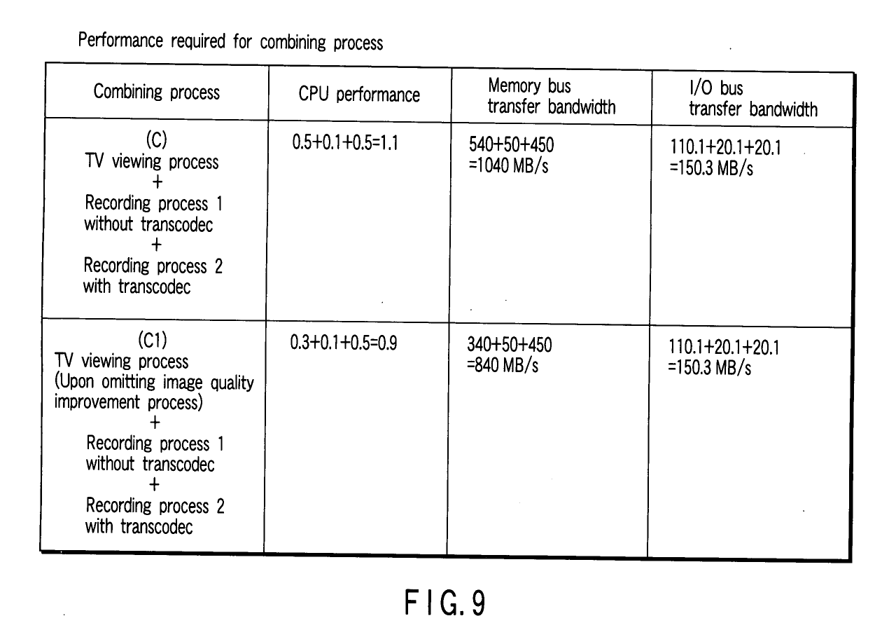

FIG. 9 shows the calculation results of the performance of the CPU 10 and the transfer bandwidths of the memory bus 13 and I/O bus 14, which are required for the process (C). That is, since the performance in the process (C) exceeds the system performance for guaranteeing the real-time operation, the process cannot be executed in real time. To cope with this, some of the plurality of real-time processes are changed (omitted) (to reduce the load), thereby executing the process (C). For example, the following process (C1) is executed.

(C1) TV viewing process (upon omitting image quality improvement process), recording process 1 without transcodec, and recording process 2 with transcodec

FIG. 9 shows the calculation results of the performance of the CPU 10 and the transfer bandwidths of the memory bus 13 and I/O bus 14, which are required for the process (C1). That is, since the performance in the process (C1) does not exceed the system performance for guaranteeing the real-time operation, the three processes, i.e., the TV viewing process (upon omitting an image quality improvement process), the recording process 1 with the transcodec, and the recording process 2 with the transcodec can be executed.

As described above, before starting the real-time process, the real-time operation is checked. If the performance exceeds the guaranteed performance, the omissible process is omitted and the real-time operation is checked again, thereby guaranteeing the real-time operation.

The CPU 10 may determine whether the plurality of designated real-time processes can be executed, in recording reservation setting. Based on the determination that the plurality of real-time processes cannot be executed, information representing that some of the plurality of designated real-time processes are to be changed (omitted) may be output. The output information is displayed on a display to notify a user that some of the real-time processes are to be changed (omitted). Also, at the display timing, the user may set some of the real-time processes to be changed (omitted) in order to reduce the load.

Furthermore, the CPU 10 may determine whether the plurality of designated real-time processes can be executed, immediately before executing the reserved recording process (e.g., 5 min before executing the reserved recording process). Based on the determination that the plurality of real-time processes cannot be executed, information representing that some of the plurality of designated real-time processes are to be changed (omitted) may be output. In this case, similarly, the output information can be displayed on the display to notify the user that some of the real-time processes are to be changed (omitted). At this display timing, the user may also set some of the processes to be changed (omitted) in order to reduce the load.

As a method of reducing the load, a filtering level may be adjusted in decoding. For example, when the filtering process is omitted, the load can be greatly reduced.

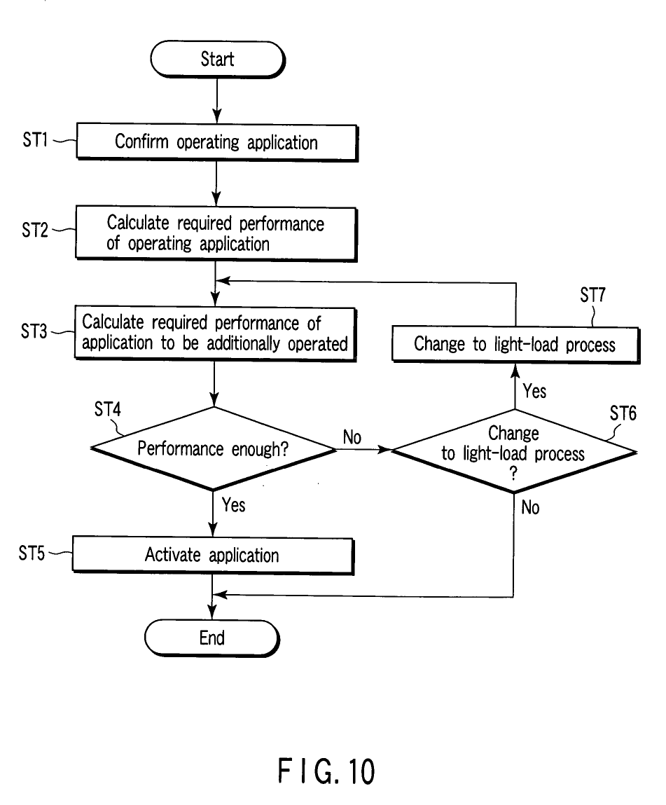

FIG. 10 is a flowchart for explaining an example of the operation control of the real-time process. As shown in FIG. 10, the CPU 10 confirms an operating application (ST1), and calculates the performance required for the operating application. The CPU 10 also calculates the performance required for a designated application (application to be additionally operated) (ST3), calculates a sum of the performances required for each of the plurality of applications, and checks whether the sum of the required performances exceeds the guaranteed performance (ST4). If the sum of the required performances does not exceed the guaranteed performance (YES in ST4), the plurality of applications are activated at a designated timing (ST5).

If the sum of the required performances exceeds the guaranteed performance (NO in ST4), the application is changed to a light-load process, or the omissible process is omitted (YES in ST6) (ST7). After that, the CPU 10 calculates the sum of the performances required for each of the plurality of applications (upon changing or omitting some applications) to check whether the sum of the required performances exceeds the guaranteed performance (ST4). If the sum of the required performances does not exceed the guaranteed performance (YES in ST4), the plurality of applications (upon changing or omitting some applications) are activated at the designated timing (ST5).

According to the above-described embodiment, the following effects can be obtained.

(1) When a plurality of application software programs are to be operated, a required performance for each application software and a guaranteed performance (the guaranteed performance of a CPU 10 and the guaranteed transfer bandwidths of the memory bus 13 and I/O bus 14) for guaranteeing a real-time operation in a system are prepared. The performance required for the application is compared with the guaranteed performance for guaranteeing the real-time operation in the system to check whether the required performance exceeds the guaranteed performance. If the required performance does not exceed the guaranteed performance, the application is operated, thereby guaranteeing the real-time operation.

(2) When a plurality of application software programs are to be operated, information representing a required performance and an omittable process for each application software, and a guaranteed performance (the guaranteed performance of the CPU 10 and the guaranteed transfer bandwidths of the memory bus 13 and I/O bus 14) for guaranteeing a real-time operation in a system are prepared. The performance required for the application is compared with the guaranteed performance for guaranteeing the real-time operation in the system to check whether the required performance exceeds the guaranteed performance. If the required performance does not exceed the guaranteed performance, the application is operated. If the required performance exceeds the guaranteed performance, an omissible process is omitted. After that, whether the required performance exceeds the guaranteed performance is checked again. If the required performance does not exceed the guaranteed performance, the application is operated, thereby performing the real-time process more flexibly.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A recording/playback apparatus comprising:
a storage unit configured to store a guaranteed performance for guaranteeing a real-time operation for each unit which performs various processes for a recording/playback process, and required performances for each unit in executing the various processes; and
a processing unit configured to calculate a sum of the required performances for each unit in executing a plurality of designated real-time processes, compare the sum of the required performances for each unit with the guaranteed performance for each unit, execute, when the sum of the required performances for the plurality of the real-time processes does not exceed the guaranteed performance, the plurality of designated real-time processes, and change, when the sum of the required performances for the plurality of the real-time processes exceeds the guaranteed performance, some of the plurality of designated real-time processes and execute the changed processes.

2. An apparatus according to claim 1, wherein
said each unit includes an information processing unit for processing recording/playback information, an input/output bus for inputting and outputting the recording/playback information between the information processing unit and an input/output processing unit, and a memory bus for inputting and outputting the recording/playback information between the information processing unit and a memory, and
the storage unit stores a guaranteed performance for guaranteeing a real-time operation in the information processing unit, a guaranteed transfer bandwidth for guaranteeing a real-time operation in the input/output bus, a guaranteed transfer bandwidth for guaranteeing a real-time operation in the memory bus, a required performance for the information processing unit in executing the various processes, a required transfer bandwidth for the input/output bus in executing the various processes, and a required transfer bandwidth for the memory bus in executing the various processes.

3. An apparatus according to claim 1, wherein
the storage unit stores a changeable process of the real-time processes and change information of the changeable process, and
the processing unit changes, when the sum of the required performances of the plurality of designated real-time processes exceeds the guaranteed performance, a changeable process of the plurality of designated real-time processes based on change information stored in the storage unit, and executes the changed process.

4. An apparatus according to claim 1, wherein
the storage unit stores a condition capable of changing a recording process with a transcodec to a recording process without the transcodec, and
the processing unit changes, when the sum of the required performances for the plurality of designated real-time processes including the recording process with the transcodec exceeds the guaranteed performance, the recording process with the transcodec to the recording process without the transcodec of the plurality of designated real-time processes, and executes the changed process.

5. An apparatus according to claim 1, wherein
the storage unit stores a condition capable of changing a playback process with an image quality improvement process to a playback process without the image quality improvement process, and
the processing unit changes, when the sum of the required performances for the plurality of designated real-time processes including the playback process with the image quality improvement process exceeds the guaranteed performance and when a real-time process which matches the condition stored in the storage unit is included, the playback processes with the image quality improvement process to the playback process without the image quality improvement process of the plurality of designated real-time processes, and executes the changed process.

6. An apparatus according to claim 1, wherein the processing unit determines whether the sum of the required performances for the plurality of designated real-time processes exceeds the guaranteed performance in recording reservation setting, displays, when the sum of the required performances for the plurality of real-time processes exceeds the guaranteed performance, that some of the plurality of designated real-time processes are to be changed and executed, and changes some of the real-time processes and executes the changed processes.

7. An apparatus according to claim 1, wherein the processing unit calculates the sum of the required performances for the plurality of designated real-time processes in recording reservation setting, outputs, when the sum of the required performances of the plurality of real-time processes exceeds the guaranteed performance, information representing that some of the plurality of designated real-time processes are to be changed and executed, calculates the sum of the required performances for the plurality of designated real-time processes even immediately before recording reservation execution, outputs, when the sum of the required performances of the plurality of real-time processes exceeds the guaranteed performance, information representing that some of the plurality of designated real-time processes are to be changed and executed, and changes some of the processes and executes the changed processes.

8. A recording/playback method comprising:
calculating, based on a guaranteed performance for guaranteeing a real-time operation for each unit which performs various processes for a recording/playback process, and required performances for each unit in executing the various processes, a sum of the required performances for each unit in executing a plurality of designated real-time processes, and comparing the sum of the required performances for each unit with the guaranteed performance for each unit; and
executing, when the sum of the required performances for the plurality of the real-time processes does not exceed the guaranteed performance, the plurality of designated real-time processes, and changing, when the sum of the required performances for the plurality of the real-time processes exceeds the guaranteed performance, some of the plurality of designated real-time processes and executing the changed processes.

9. A method according to claim 8, wherein said each unit includes an information processing unit for processing recording/playback information, an input/output bus for inputting and outputting the recording/playback information between the information processing unit and an input/output processing unit, and a memory bus for inputting and outputting the recording/playback information between the information processing unit and a memory, and stores a guaranteed performance for guaranteeing a real-time operation in the information processing unit, a guaranteed transfer bandwidth for guaranteeing a real-time operation in the input/output bus, a guaranteed transfer bandwidth for guaranteeing a real-time operation in the memory bus, a required performance for the information processing unit in executing the various processes, a required transfer bandwidth for the input/output bus in executing the various processes, and a required transfer bandwidth for the memory bus in executing the various processes.

10. A method according to claim 8, further comprising changing, when the sum of the required performances of the plurality of designated real-time processes exceeds the guaranteed performance, a changeable process of the plurality of designated real-time processes, and executing the changed process.

11. A method according to claim 8, further comprising changing, when the sum of the required performances for the plurality of designated real-time processes including a recording process with a transcodec exceeds the guaranteed performance, the recording process with the transcodec to a recording process without the transcodec of the plurality of designated real-time processes, and executing the changed process.

12. A method according to claim 8, further comprising changing, when the sum of the required performances for the plurality of designated real-time processes including a playback process with an image quality improvement process exceeds the guaranteed performance, the playback processes with the image quality improvement process to a playback process without the image quality improvement process of the plurality of designated real-time processes, and executing the changed process.

13. A method according to claim 8, further comprising determining whether the sum of the required performances for the plurality of designated real-time processes exceeds the guaranteed performance in recording reservation setting, displaying, when the sum of the required performances for the plurality of real-time processes exceeds the guaranteed performance, that some of the plurality of designated real-time processes are to be changed and executed, and changing some of the real-time processes and executing the changed processes.

14. A method according to claim 8, further comprising calculating the sum of the required performances for the plurality of designated real-time processes in recording reservation setting, outputting, when the sum of the required performances of the plurality of real-time processes exceeds the guaranteed performance, information representing that some of the plurality of designated real-time processes are to be changed and executed, calculating the sum of the required performances for the plurality of designated real-time processes even immediately before recording reservation execution, outputting, when the sum of the required performances of the plurality of real-time processes exceeds the guaranteed performance, information representing that some of the plurality of designated real-time processes are to be changed and executed, and changing some of the processes and executing the changed processes.
